(19) United States
(12) Patent Application Publication
(10) Pub. No.: US 2016/0034866 A1
(43) Pub. Date: Feb. 4, 2016

(54) FRIENDLY FUNDING SOURCE MESSAGING

(71) Applicant: PAYPAL, INC., San Jose, CA (US)

(72) Inventor: Sridhar Sivaraman, Chennai (IN)

(21) Appl. No.: 14/879,972

(22) Filed: Oct. 9, 2015

Related U.S. Application Data
(63) Continuation of application No. 13/443,554, filed on Apr. 10, 2012.

(51) Int. Cl. G06Q 20/10; G06Q 20/32

(52) U.S. Cl. CPC G06Q 20/102; G06Q 20/3255

(57) ABSTRACT

A sender can request payment of a third party invoice by messaging a receiver. The receiver may accept or deny the payment request. The request to pay a particular invoice may be sent via a sender through an on-line request, electronic mail and/or text messaging to a receiver who may have an account with an on-line payment provider. Upon receiving the request, the receiver may accept or decline the payment request via electronic mail and/or text messaging. If the receiver accepts the payment request, the amount of the invoice is deducted out of their on-line payment provider account.

### CROSS REFERENCE TO RELATED APPLICATION

The present application is a continuation of U.S. patent application Ser. No. 13/443,554, filed Apr. 10, 2012, entitled “FRIENDLY FUNDING SOURCE MESSAGING”, Attorney Docket No. 70481.526, disclosure of which are incorporated herein by reference.

### BACKGROUND

1. Field of the Invention

The present invention generally relates to on-line, electronic mail and text messaging payments, and in particular, to funding of on-line and message payment requests.

2. Related Art

More and more consumers are purchasing items and services over electronic networks, such as the Internet. Consumers routinely need and purchase products and services from merchants, service providers and individuals alike. Likewise, merchants, service providers and individuals are billing those that purchase from them, i.e., clients, via on-line, electronic mail or text-message invoicing or billing. The transactions can take place directly between a company, merchant or retailer and the consumer, where payment is typically made by entering credit card or other financial information. Transactions can also take place with the aid of an payment provider, such as PayPal, Inc. of San Jose, Calif. Such payment providers can make transactions easier and safer for the parties. Payment providers enable payments to be made through many different convenient methods.

When making a payment, the payer, user of the services, or consumer typically specifies a funding source for the payment. Examples of funding sources can be an account with the payment provider, a credit card, a bank or checking account, or the like. When the user specifies a funding source, the payment provider may process the payment request to determine whether the user has sufficient funds or credit to make the payment. If so, the payment request is approved, and the purchase is completed. However, if there are insufficient funds or credit, the payment request may be denied, resulting a lost sale for the seller or payee and a lost purchase or payment by the buyer or payer.

### SUMMARY

In one embodiment, the present invention describes a method of performing financial transaction including sending a request message from a sender for a payment of a third party invoice to a recipient, receiving, from a sender, the request message for the payment, and responding to the request message. In a further embodiment, the invention further includes processing, by the payment provider, the request for the payment based on the response of the recipient. In some embodiments, the recipient has an account with the payment provider. In some embodiments, the recipient responds to the request message by accepting responsibility for the payment of the third party invoice. In further embodiments, the payment provider processes payment directly from the recipient's account upon the recipient responding to the request message by accepting responsibility for payment of the third party invoice. In yet still further embodiments, the sender receives a confirmation message that the payment by the recipient to the third party has been made. In some embodiments, the method further includes receiving from the recipient to the payment provider a modification for the use of the recipient's payment. In some embodiments, the recipient responds to the request message by denying the request for payment. In some embodiments, the sender receives a message that the recipient has denied the request for payment. In some embodiments, the sender request that only a portion of the third party invoice be paid by the recipient. In further embodiments, the recipient doesn't respond to the payment request within a specific time interval, thereby invalidating the request.

In one embodiment, the present invention describes a method of performing financial transactions, including receiving, electronically by a processor of a payment provider, a request from a recipient for a payment on behalf of a sender in response to the recipient receiving a payment request from the sender; determining information about a payee, a payment amount, and the recipient; determining whether the recipient has an account with the payment provider that can be used to make the payment; and processing the payment to the payee. In some embodiments, the payment request is for payment of at least a portion of a payee invoice. In some embodiments, the method further includes setting up an account for the recipient with the payment provider if the payment provider determines that the recipient doesn't have an account and/or the recipient's account is invalid. In some embodiments, the method further includes sending an electronic confirmation message to the recipient that the payment by the recipient to the payee has been made. In some embodiments, the payment provider processes payment directly from the recipient's account upon the payment provider receiving the recipient's request. In further embodiments, the method further includes sending an electronic confirmation message to the sender that the payment by the recipient to the payee has been made. In some embodiments, the method further includes receiving, electronically by a processor of a payment provider, from the recipient a modification for the use of the recipient's payment. In some embodiments, determining whether the recipient has an account with the payment provider is based on personal information provided by the recipient to the payment provider. In some embodiments, the information about a payee, a payment amount, and the recipient is provided for in the recipient's request. In some embodiments, the information about the recipient comprises a username, email address, phone number, credit card information, bank information, personal identification number (PIN), password, and address. In further embodiment, the sender is known by the recipient.

The present invention, in one embodiment, is also directed to a non-transitory machine-readable medium including a plurality of machine-readable instructions which when executed by one or more processors of a server are adapted to cause the server to perform a method including receiving a request for a payment to a third party from a recipient on behalf of a sender, determining available funding sources for the recipient, wherein the recipient has an account with a payment provider, receiving selected funding sources from the recipient, and processing the request for payment to a third party based on the selected funding sources. In some embodiments, the request is for a partial payment of the amount requested by the sender. In some embodiments, the method further includes notifying the recipient of the processing of the payment. In some embodiments, the recipient is known by the sender. In further embodiments, the processing of the request results in a non-payment of the request.

The present invention, in one embodiment, is also directed to an electronic payment processing system including means for transmitting a request for payment of third party invoice from a sender to a recipient, means for receiving a request for payments of a third party invoice to a recipient having an account with a payment provider from a sender, means for transmitting a response to the request for payment from the recipient to the payment provider, and means for processing the payment based on the recipient's response. In some embodiments, the system further includes means for transmitting the status of the payment from the payment provider to the sender. In some embodiments, the system further includes means for placing a limit on the amount that can be requested by the sender. In further embodiments, the sender has an account with the payment provider.

The present invention, in one embodiment, is also directed to an electronic payment processing system including a memory storing user account information, wherein the information comprises funding sources for a user account and any restrictions on the funding sources; and one or more processors in communication with the memory configured to receive by a payment provider, a request from a recipient for a payment on behalf of a sender in response to the recipient receiving a payment request from the sender; determine information about a payee, a payment amount, and the recipient; determine whether the recipient has an account with the payment provider that can be used to make the payment; and process the payment to the payee. In some embodiments, the one or more processors in communication with the memory is further configured to transmit the status of the payment from the payment provider to the sender. In some embodiments, the sender does not have an account with the payment provider. In further embodiments, the payment request from the sender is for payment of a third party invoice.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process in sending, receiving, and processing a request for payment of a third party invoice according to one embodiment of the invention;

FIG. 2 is a flowchart showing a process for a payment provider in processing a payment using information from a friendly funding source message according to one embodiment of the invention;

FIG. 3 is block diagram of a networked system suitable for implementing the process of FIGS. 1 and 2 according to an embodiment; and

FIG. 4 is a block diagram of a system suitable for implementing one or more components in FIG. 3 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

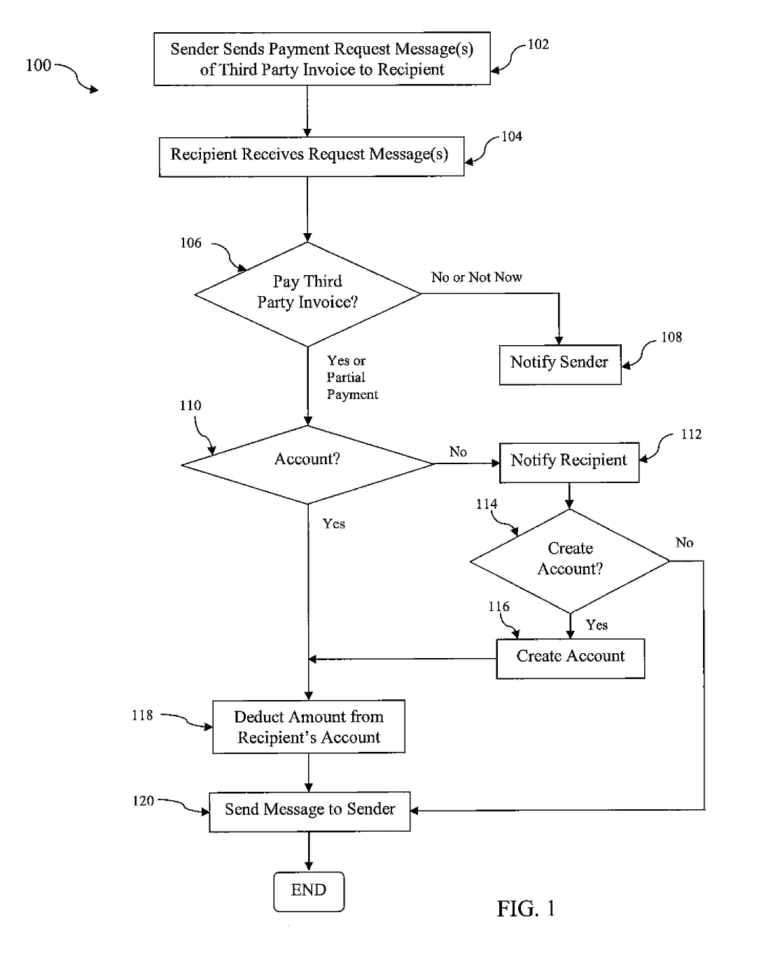

FIG. 1 is a flowchart 100 showing a process in sending, receiving, and processing a request for a payment of a third party invoice, according to one embodiment. Initially, the sender receives an invoice to be paid by the sender or on the sender's behalf, from a third party (step not shown). The third party may be any person or entity that is able to send a bill to a sender in any format, either electronically or via postal services. The third party may sell goods or services to the sender and the sender is typically a customer of the third party. The third party should be able to receive payment from a payment provider such as PayPal, Inc. of San Jose, Calif. In one embodiment, the third party sends the invoice, or request for payment electronically, such as via e-mail, text messaging, etc. Examples of third parties can include customer service providers such as a utility companies, sellers on websites such as those found on Ebay.com (Ebay, Inc., San Jose, Calif.), credit card companies, loan companies, insurance companies, etc., and billing aggregators or consolidators.

At step 102, the sender sends a payment request message, typically through a personal computer (PC), laptop, mobile phone, smart phone, computing tablet, or other computing device, for payment of at least a portion of the third party invoice to at least one recipient, typically a friend. The request message may be for the full amount of the invoice or it may be for a partial amount of the invoice. In some embodiments, the sender may send multiple message requests to the same friend or may send message requests to multiple friends to cover the cost of the third party invoice. The recipient or friend is someone or something who may give approval for another to use a certain amount of the friend's funds to fund the payment of at least a portion of the third party invoice. The sender sends the payment request message electronically, such as via e-mail and/or text message. In some embodiments, the sender simply forwards the electronic third party invoice to the recipient to request payment. At step 104, the recipient receives the electronic request message for payment of at least a portion of the third party invoice. The recipient typically receives the message on a personal computer (PC), laptop, mobile phone, smart phone, computing tablet, or other computing device.

At step 106, the recipient or friend determines whether the recipient is able to or desires to pay the third party invoice sent by the sender. The recipient can click on a button within the message request indicating the recipient's choice. For example, the button(s) within the message request can indicate “Accept” or “Yes” to accept responsibility for the payment, “Decline” or “No” to decline responsibility for the payment, “Not Now” to indicate that a choice will be decided upon later, or “Partial Payment” to indicate that the recipient will only pay a portion of the requested amount. Optionally, at step 108, the sender is electronically notified should the recipient indicate that they will not make the payment or that they will not make the payment upon receipt of the message. In some instances, the recipient may click “Not Now” or not respond at all to the message. If the recipient does not follow-up with a response or does not respond to the message at all within a certain time period, the request may expire and notification may be sent to the sender that the recipient was not responsive.

At step 110, should the recipient determine that they are going to make at least a partial payment of the third party invoice, it is then determined whether the recipient has an account with a payment provider. This can be done by searching an account database of the payment provider with the recipient information. If the recipient doesn't have an account with a payment provider, then the recipient is notified that no account exists for them to make the payment at step 112. The recipient can then determine whether to create a payment provider account at step 114. If no account exists, the recipient may be asked to enter information again, as the original information may have been entered incorrectly. If still no account is found, an account may be created or registered at step 116. To register or create an account, the recipient typically enters the payment provider site, such as through a PC, laptop, smart phone, computing tablet, or other computing device. Account creation may include the payment provider requesting certain information from the recipient, such as a username, email address, phone number, credit card information, bank information, personal identification number (PIN), password, and/or address. Using the requested information, the payment provider creates an account for the recipient at step 116. Note that if an account was found, but not valid, such as expired funding source, expired account, etc., the payment provider may only need to request a limited amount of information to re-activate the account, such as a valid funding source. Without a response or with an affirmative indication that the recipient does not want to open an account, the process ends. If the recipient decides not to create a payment provider account, then at step 120 an electronic message is optionally sent back to the sender indicating that no payment would be made of the third party invoice.

If the recipient has a payment provider account or has created an account at step 116, then the total or partial amount of the third party invoice is deducted from the recipient's account at step 118. This may require the recipient entering account identifying information, such as a username, email address, mobile phone number, passcode or PIN, but would not necessarily require the recipient to log onto the payment provider website. If the recipient wants to pay only a partial amount of the third party invoice, then the recipient may need to enter an amount to be paid on behalf of the sender. Optionally, the recipient may also indicate a particular funding source to deduct the amount from. Once the full or partial amount is deducted from the recipient's account, then an electronic message is sent to the sender confirming payment of the third party invoice at step 120.

Optionally, once a payment provider account is created (step 116) or found for the recipient, the recipient may create funding limits for the particular sender or particular third party invoice via the payment provider. The recipient may enter limits for the particular sender. The recipient may set specific limits or different limits may be provided by the payment provider for the recipient to select. Examples of limits include: 1) a dollar amount to be funded per transaction, 2) a dollar amount to be funded per day, per week, per month, or other time period, 3) a total number of transactions per day, per week, per month, or other time period, 4) certain categories for funding or certain categories for not funding, 5) certain payees for funding or certain payees for not funding, 6) different funding limits for different categories of purchases, and/or 7) a time limit for when the funding will be available or will expire. Various combinations of the above or other limits can be set for the recipient to control funding for the sender via the recipient's payment provider account.

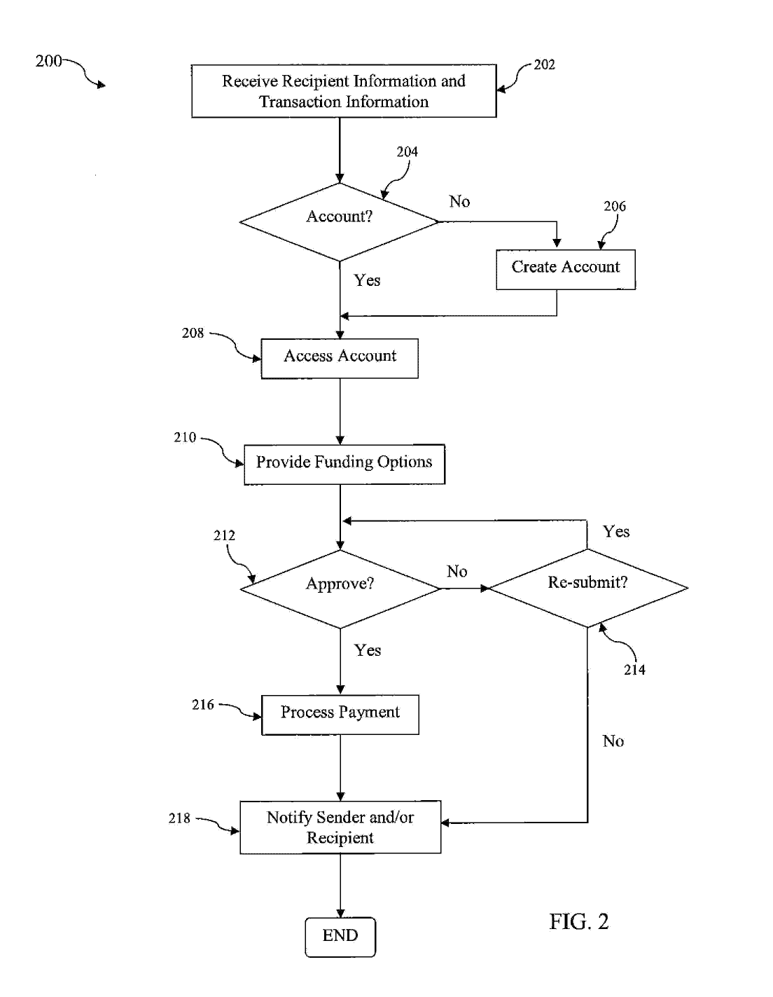

FIG. 2 is a flowchart 200 showing a process for a payment provider in making a payment using a friendly funding source messaging system according to one embodiment. At step 202, the payment provider receives recipient and transaction information. Transaction information may include sender identification, merchant identification, including a merchant account identifier, and invoice information, including, for example, price, tax, shipping costs, and totals. The transaction information may be received by an indication that the recipient is ready for check-out or payment of selected third party invoice(s). For example, the recipient may indicate a desire to pay by simply clicking “Accept” or “Yes” on the message from the sender and the details of the transaction would then automatically be transmitted to the payment provider. As an alternative, the recipient may enter or select the desired invoices to be paid by placing them in a cart on the payment provider site and selecting a button or link, such as “Checkout,” “Pay,” “Continue,” etc. This may transmit or lead to transmitting the transaction information to the payment provider. The recipient is the customer, consumer, or the entity/person making a payment. Recipient information may include the user's name, email address, phone number, username, password, PIN, and/or other identifier for the payment provider. The payment provider may receive the recipient information without accessing the payment provider web site, such as by the use of email or text messaging or by accessing the payment provider web site, such as through use of a PC, laptop, mobile phone, smart phone, or other electronic or computing device. Receipt of the recipient's account information and/or the transaction information by the payment provider may be accomplished by the recipient clicking “Accept” or “Yes” on the message from the sender. Transmittal of the recipient and transaction information may also be accomplished by the recipient entering a PIN or passcode along with the recipient clicking on “Accept” or “Yes.”

At step 204, the payment provider determines whether the recipient has an account with the payment provider, based on the information received at step 202. The payment provider may make the determination by searching an account database using the information provided. Results may include no account exists, an active account exists, or an inactive account exists. If the payment provider does not find a valid or active account, the payment provider may create an account for the recipient, at step 206, if desired by the recipient. This may include the user entering requested information, such as name, email address, phone number, mailing address, credit card or bank information, social security number, password, PIN, etc.

Once the recipient's account is created (step 206) or found (step 204), the payment provider accesses the account at step 208. Accessing the account allows the payment provider to determine certain information about the recipient and/or the account, such as account limits or restrictions, available funding sources, etc. It also enables the payment provider to make any determinations about the authenticity of the recipient.

Optionally, the payment provider determines funding options for the recipient and the transaction, such as based on the recipient information and/or the transaction information. For example, the recipient may have specific funding options associated with the account. Conventional funding options may include a recipient bank/checking account and one or more credit cards. The recipient may also have limits to these conventional funding options, such as limits imposed by the instrument or a recipient controlling the instrument.

The available funding sources are then provided to the recipient at step 210. The friendly funding sources may include an identification of the person, such as the recipient's name or email address. Other information may include any restrictions for the funding source, such as limits. In one embodiment, the payment provider only provides or shows sources that can be used with the particular transaction associated with the sender. Thus, even though the recipient may be associated with several different funding sources, the specifics of the transaction may exclude one or more of those sources. In other embodiments, all funding sources are shown to the recipient, regardless of whether one or more may be unusable due to the details of the transaction.

Based on the funding sources provided by the payment provider, the recipient selects one or more funding sources as payment for the transaction. Selection may be by simply checking a box next to desired ones of the funding sources or other selection means, such as clicking on the desired funding source. The selected funding source(s) are then communicated to and received by the payment provider.

Next, the payment provider determines whether to approve the payment at step 212. The determination process may include checking on limits or restrictions associated with the recipient's account, the details of the transaction or purchase, and the availability of one or more selected funding sources. Any number of reasons may cause the transaction to be declined, such as any indication of a fraudulent transaction, the type of transaction, purchase, or merchant was specifically forbidden, spending limits have been reached or exceeded, and/or insufficient funds for the transaction amount. For example, the recipient may have selected one or more funding sources that are not available for this transaction or recipient based restrictions placed on the funding sources and/or the funding sources selected are insufficient to fund the transaction amount.

If the requested payment is not approved, the recipient may have the option of re-submitting the request by changing one or more parameters, such as adding a funding source and/or changing a funding source. If the recipient wishes to re-submit the request, as determined at step 214, the recipient re-submits the request to pay the third party invoice and the payment provider may receive new funding sources. Processing of the payment would then continue as before. If the recipient does not wish to re-submit the request or the recipient is not given the option of re-submitting (such as in the case where the reason for not approving the transaction was based on the actual type of transaction), then the transaction ends without a payment. Optionally, at step 218, the sender and/or recipient is notified that the transaction has not been completed.

However, if the transaction request is approved, the payment provider processes the payment at step 216. The processing may include debiting the appropriate amount of funds from each of the specified funding sources and/or accounts, crediting the appropriate amount of funds to the third party, and notifying the third party that the payment request has been approved. Notification can be by any means, including email, text, through the third party website site, etc. Once notified, the third party can release, ship, or otherwise transfer the purchase to the sender or simply further notify the sender that the invoice has been paid. Optionally, the recipient and/or sender may be notified by the payment provider that the invoice has been paid at step 218. The notification may be through email, text, phone call, or notification on the recipient's account page with the payment provider. The recipient and/or sender may be informed about various details of the transaction, including amount of funds used, total amount of the transaction, description of the purchase, identification of the merchant, payee or third party, and the date of the transaction.

Therefore, using embodiments of the present invention, a sender may be able to make a purchase or pay an invoice, where in the past, the sender may not have been able to make the purchase. The reason is that one or more recipients or friends have allowed the user to use at least a portion of their account as a funding source for the purchase or payment of the invoice. This results in a payment that otherwise may not have happened. The recipient can control the use of their funds at any time, which limits exposure or abuse of these additional funding sources.

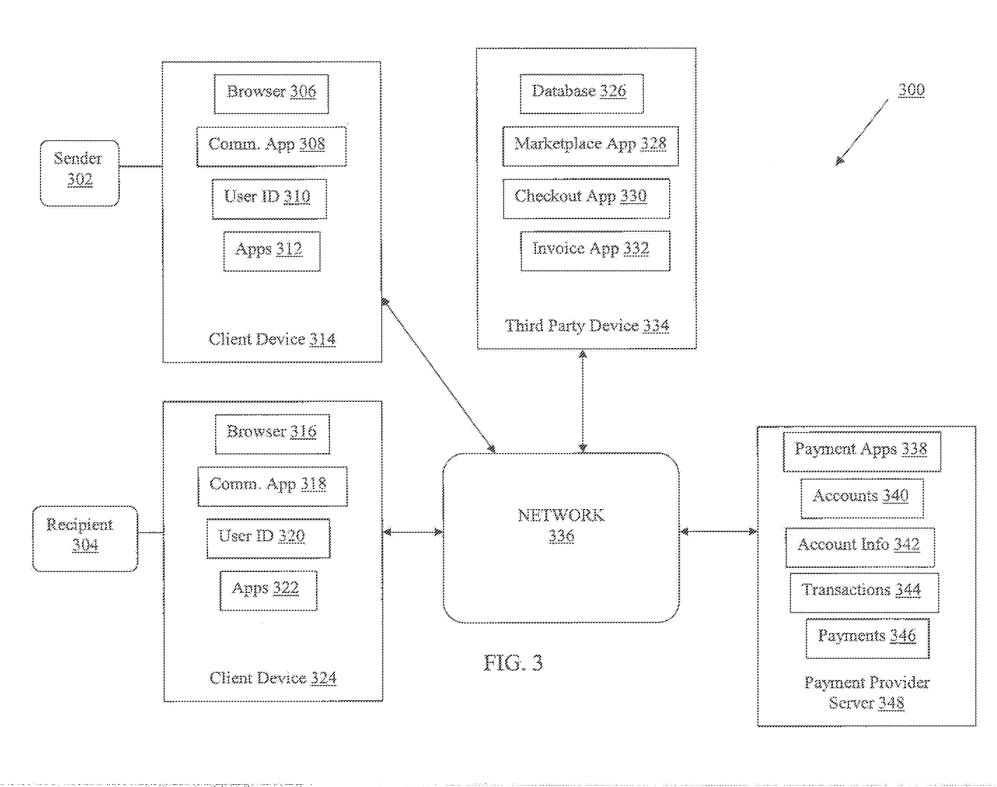

FIG. 3 is a block diagram of a networked system 300 configured to handle a financial transaction between a sender, a recipient (e.g., a friend) and a third party, such as described above, in accordance with an embodiment of the invention. System 300 includes a first client device 314, a second client device 324, a third party device 334, and a payment provider server 348 in communication over a network 336. Payment provider server 348 may be maintained by a payment provider, such as PayPal, Inc. of San Jose, Calif. A sender 302, utilizes first client device 314, and a recipient 304, such as a friend, utilizes second client device 324, where the first client device 314 is used to send a payment request of a third party invoice to the second client device 324 and the second client device 324 is used to receive the payment request from the first client device 314 and perform a payment transaction with a third party device 334 using payment provider server 348.

First client device 314, second client device 324, third party device 334, and payment provider server 348 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 336.

Network 336 may be implemented as a single network or a combination of multiple networks. For example, in various embodiments, network 336 may include the Internet or one or more intranets, landline networks, wireless networks, and/or other appropriate types of networks.

First client device 314 and second client device 324 may be implemented using any appropriate hardware and software configured for wired and/or wireless communication over network 336. For example, in one embodiment, the two client devices may be implemented as a personal computer (PC), a smart phone, a mobile phone, personal digital assistant (PDA), laptop computer, and/or other types of computing devices capable of transmitting and/or receiving data, such as an iPad™ from Apple™.

First client device 314 may include one or more browser applications 306 which may be used, for example, to provide a convenient interface to permit sender 302 to browse information available over network 336. For example, in one embodiment, browser application 306 may be implemented as a web browser configured to view information available over the Internet. First client device 314 may also include one or more applications 312 which may be used, for example, to provide client-side processing for performing desired tasks in response to operations selected by sender 302. In one embodiment, a toolbar application may display a user interface in connection with browser application 306 as further described herein. First client device 314 may further include other applications 312 as may be desired in particular embodiments to provide desired features to first client device 314. For example, other applications 312 may include security applications for implementing client-side security features, programmatic client applications for interfacing with appropriate application programming interfaces (APIs) over network 328, or other types of applications. Applications 312 may also include email, texting, voice and IM applications that allow sender 302 to send and receive emails, calls, and texts through network 336, as well as applications that enable the sender arrange to make payments through the payment provider as discussed above. First client device 314 includes one or more user identifiers 310 which may be implemented, for example, as operating system registry entries, cookies associated with browser application 306, identifiers associated with hardware of first client device 314, or other appropriate identifiers, such as used for payment/user/device authentication. In one embodiment, user identifier 310 may be used by a payment service provider to associate sender 302 with a particular account maintained by the payment provider as further described herein. A communications application 308, with associated interfaces, enables first client device 314 to communicate within system 300 and may be used to send a request message to the recipient 304, such as via text messaging.

Second client device 324 may have similar applications and modules as first client device 314, but is used, in this example, for receiving messages sent by sender 302 via the first client device 314 and for paying for third party invoices sent via the sender through use of a payment provider. Restrictions, limitations, and conditions may be placed for each designated sender. Second client device 324 may also include one or more browser applications 316 and one or more applications 322 which may be used, for example, to provide a convenient interface to permit recipient 304 to browse information and perform tasks over network 336. For example, in one embodiment, browser application 316 may be implemented as a web browser configured to view information available over the Internet and communicate with payment provider server 348 to receive and send information about paying a third party invoice based on a request message from a sender 302.

Second client device 324 may further include other applications 322 such as security applications for implementing client-side security features, programmatic client applications for interfacing with appropriate application programming interfaces (APIs) over network 336, or other types of applications. Applications 322 may also include email, text, IM, and voice applications that allow recipient 304 to communicate through network 336, receive messages from sender 302, and create and manage funding sources. Second client device 324 includes one or more user identifiers 320 which may be implemented, for example, as operating system registry entries, cookies associated with browser application 316, identifiers associated with hardware of second client device 316, or other appropriate identifiers, such as used for payment/recipient/device authentication, e.g., the phone number associated with second client device 316. Identifiers may be used by a payment service provider to associate recipient 304 with a particular account maintained by the payment service provider.

The third party device 334 may be maintained, for example, by an on-line merchant or seller offering various products and/or services in exchange for payment to be received over network 336. Generally, the third party device 334 may be maintained by anyone or any entity that receives money, which includes charities as well as retailers. The third party device 334 includes a database 326 identifying available products and/or services (e.g., collectively referred to as “items”) which may be made available for viewing and purchase by sender 302. Accordingly, the third party device 334 also includes a marketplace application 328 which may be configured to serve information over network 336 to browser 306 of first client device 314 and, optionally, the second client device 324. In one embodiment, sender 302 may interact with marketplace application 328 through browser applications over network 336 in order to view various products or services identified in database 326.

The third party device 334 also may include a checkout application 330 which may be configured to facilitate the purchase by sender 302 of goods or services identified by marketplace application 328. Checkout application 330 may be configured to accept payment information on the recipient 304 from the sender 302 through payment service provider server 348 over network 336. For example, checkout application 330 may receive and process a payment confirmation from payment service provider server 348, as well as transmit transaction information to the payment provider and receive information from the payment provider (e.g., a transaction ID). Checkout application 330 may also be configured to accept one or more different funding sources, including funding sources, for payment.

The third party device 334 may also include an invoice application 332 which may be configured to bill the sender 302 for the provision of goods and services. The invoice application 332 may bill the sender 302 once or on a routine basis. The invoice application 332 may transmit information to the sender via the first client device browser 306, any application 312 and/or communication application 308.

Payment provider server 348 may be maintained, for example, by an online payment service provider which may provide payment between recipient 304 and the operator of the third party device 334, as well as provide payment services for sender 302. In this regard, payment provider server 348 includes one or more payment applications 338 which may be configured to interact with first client device 314, second client device 324, and/or third party device 334 over network 336 to facilitate the payment for goods or services rendered to sender 302 by recipient 304.

Payment provider server 348 also maintains a plurality of user accounts 340, each of which may include account information 342 associated with individual users. For example, account information 342 may include private financial information of users of devices such as account numbers, passwords, device identifiers, user names, phone numbers, credit card information, bank information, or other financial information which may be used to facilitate online transactions by recipient 304 and optionally, by sender 302. Advantageously, payment application 338 may be configured to interact with third party device 334 on behalf of recipient 304 during a transaction with checkout application 330 to track and manage purchases made by sender 302 and which funding sources are used.

A transaction processing application 344, which may be part of payment application 338 or separate, may be configured to receive information from a client device and/or third party device 334 for processing and storage in a payment database 346. Transaction processing application 344 may include one or more applications to process information from sender 302 and/or recipient 304 for processing a payment using a recipient's funding source as described herein. Other funding sources may also be processed through this application. Payment application 338 may be further configured to determine the existence of and to manage accounts for recipient 304, and optionally sender 302, as well as create new accounts if necessary, such as the set up, management, and use of various funding sources.

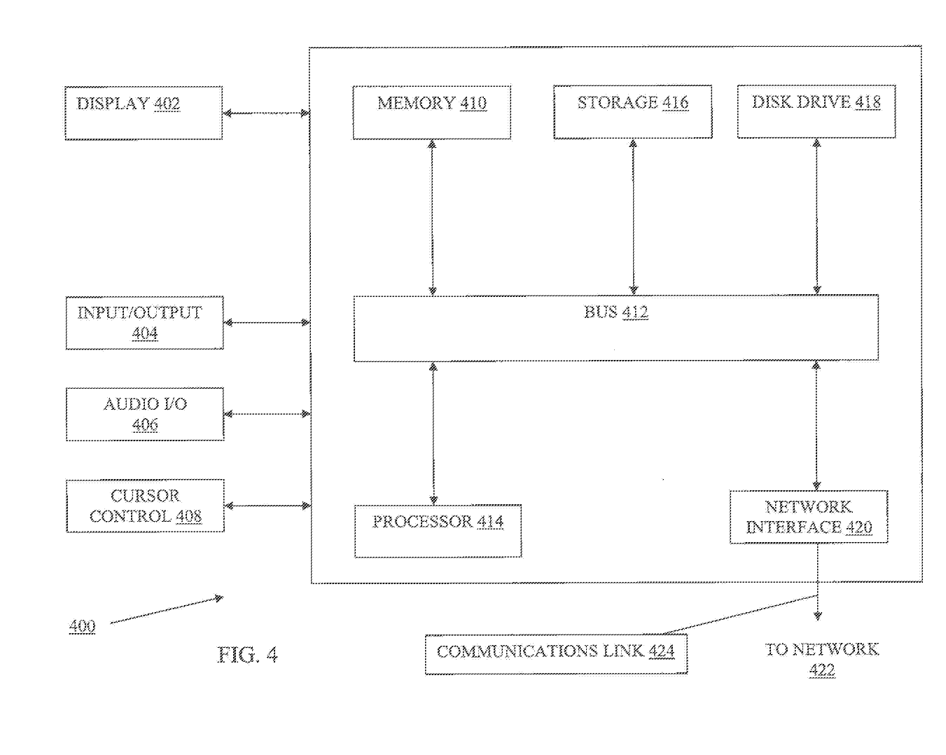

FIG. 4 is a block diagram of a computer system 400 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The third party and/or payment provider may utilize a network computing device (e.g., a network server) capable of communicating with the network. It should be appreciated that each of the devices utilized by senders, receivers, third parties (i.e., merchants), and payment providers may be implemented as computer system 400 in a manner as follows.

Computer system 400 includes a bus 412 or other communication mechanism for communicating information data, signals, and information between various components of computer system 400. Components include an input/output (I/O) component 404 that processes a user (i.e., sender, recipient, third party and/or payment provider) action, such as selecting keys from a keypad/keyboard, selecting one or more buttons or links, etc., and sends a corresponding signal to bus 412. I/O component 404 may also include an output component, such as a display 402 and a cursor control 408 (such as a keyboard, keypad, mouse, etc.). An optional audio input/output component 406 may also be included to allow a user to use voice for inputting information by converting audio signals. Audio I/O component 406 may allow the user to hear audio. A transceiver or network interface 420 transmits and receives signals between computer system 400 and other devices, such as another user device, a merchant server, or a payment provider server via network 328. In one embodiment, the transmission is wireless, although other transmission mediums and methods may also be suitable. A processor 414, which can be a micro-controller, digital signal processor (DSP), or other processing component, processes these various signals, such as for display on computer system 400 or transmission to other devices via a communication link 424. Processor 414 may also control transmission of information, such as cookies or IP addresses, to other devices.

Components of computer system 400 also include a system memory component 410 (e.g., RAM), a static storage component 416 (e.g., ROM), and/or a disk drive 418. Computer system 400 performs specific operations by processor 414 and other components by executing one or more sequences of instructions contained in system memory component 410. Logic may be encoded in a computer readable medium, which may refer to any medium that participates in providing instructions to processor 414 for execution. Such a medium may take many forms, including but not limited to, non-volatile media, volatile media, and transmission media. In various implementations, non-volatile media includes optical or magnetic disks, volatile media includes dynamic memory, such as system memory component 410, and transmission media includes coaxial cables, copper wire, and fiber optics, including wires that comprise bus 412. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 424 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. The above description focuses on a third party invoice to be paid in whole or in part by a recipient on behalf of a sender. However, the payment or request for payment need not be for a generated invoice, but can be for an intended purchase in which an invoice has not yet been created. For example, a sender may want to purchase an item from a merchant or third party, where the item is placed in a cart, but not yet paid for. Thus, different types of requests for payment by a recipient on behalf of a sender may also be suitable. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method of processing a payment on behalf of a third party, comprising:
in response to receiving a request from a sender, sending, by a processor of a payment provider, a message request to a recipient for a payment to a merchant on behalf of the sender, wherein the message request includes a user selectable option for the recipient to accept responsibility for the payment without requiring the recipient to access a payment provider site;
determining whether the user selectable option has been selected by the recipient; and
in response to a determination that the user selectable option has been selected by the recipient, processing the payment from the recipient's account.

2. The method of claim 1, wherein the message request is an e-mail message to the recipient.

3. The method of claim 1, wherein the message request is a text message to the recipient.

4. The method of claim 1, further comprising:
in response to the determination that the user selectable option has been selected by the recipient, sending a notification to the sender that the recipient has accepted responsibility for the payment.

5. The method of claim 1, wherein the message request includes a second user selectable option for the recipient to decline responsibility for the payment, the method further comprising:
in response to a determination that the second user selectable option has been selected by the recipient, sending a notification to the sender that the recipient has declined responsibility for the payment.

6. The method of claim 1, wherein the message request includes a third user selectable option for the recipient to accept responsibility for at least a portion of the payment, the method further comprising:
in response to a determination that the third user selectable option has been selected by the recipient, sending a notification to the sender that the recipient has accepted responsibility for at least the portion of the payment.

7. The method of claim 1, wherein the message request includes a fourth user selectable option indicating that the recipient will decide later whether to accept responsibility for the payment, the method further comprising:
in response to a determination that the fourth user selectable option has been selected by the recipient, sending a notification to the sender that the recipient will decide later whether to accept responsibility for the payment.

8. The method of claim 1, further comprising:
in response to the determination that the recipient has accepted responsibility for at least a portion of the payment:
searching a database for the recipient's account, wherein the database stores information about one or more user accounts; and
deducting at least the portion of the payment from the recipient's account.

9. The method of claim 8, wherein the recipient has accepted responsibility for at least the portion of the payment, the method further comprising:
receiving from the recipient an amount to be paid on behalf of the sender, wherein the amount is equal to the portion of the payment for which the recipient has accepted responsibility.

10. The method of claim 1, further comprising:
in response to the selection of the user selectable option, receiving the recipient's account information.

11. The method of claim 1, further comprising:
in response to the selection of the user selectable option and to a passcode entered into the message request by the recipient, receiving the recipient's account information.

12. A system for processing a payment on behalf of a third party, comprising:
a non-transitory memory storing information about one or more user accounts; and
one or more hardware processors coupled to the non-transitory memory and configured to read instructions from the non-transitory memory to cause the system to perform operations comprising:
in response to receiving a request from a sender, sending, by a processor of a payment provider, a message request to a recipient for a payment to a merchant on behalf of the sender, wherein the message request includes a user selectable option for the recipient to accept responsibility for the payment without requiring the recipient to access a payment provider site;
determining whether the user selectable option has been selected by the recipient; and
in response to a determination that the user selectable option has been selected by the recipient, processing the payment from the recipient's account.

13. The system of claim 12, wherein the message request includes a second user selectable option for the recipient to decline responsibility for the payment, wherein the operations further comprise:
in response to a determination that the second user selectable option has been selected by the recipient, sending a notification to the sender that the recipient has declined responsibility for the payment.

14. The system of claim 12, wherein the message request includes a third user selectable option for the recipient to accept responsibility for at least a portion of the payment, wherein the operations further comprise:
in response to a determination that the third user selectable option has been selected by the recipient, sending a notification to the sender that the recipient has accepted responsibility for at least the portion of the payment.

15. The system of claim 12, wherein the message request includes a fourth user selectable option indicating that the recipient will decide later whether to accept responsibility for the payment, wherein the operations further comprise:
in response to a determination that the fourth user selectable option has been selected by the recipient, sending a notification to the sender that the recipient will decide later whether to accept responsibility for the payment.

16. The system of claim 12, wherein the operations further comprise:
in response to the determination that the user selectable option has been selected by the recipient, sending a notification to the sender that the recipient has accepted responsibility for the payment.

17. A non-transitory machine-readable medium having stored thereon machine-readable instructions executable to cause a machine to perform operations comprising:
in response to receiving a request from a sender, sending, by a processor of a payment provider, a message request to a recipient for a payment to a merchant on behalf of the sender, wherein the message request includes a user selectable option for the recipient to accept responsibility for the payment without requiring the recipient to access a payment provider site;
determining whether the user selectable option has been selected by the recipient; and
in response to a determination that the user selectable option has been selected by the recipient, processing the payment from the recipient's account.

18. The non-transitory machine-readable medium of claim 17, wherein the message request includes a second user selectable option for the recipient to decline responsibility for the payment, wherein the operations further comprise:
in response to a determination that the second user selectable option has been selected by the recipient, sending a notification to the sender that the recipient has declined responsibility for the payment.

19. The non-transitory machine-readable medium of claim 17, wherein the message request includes a third user selectable option for the recipient to accept responsibility for at least a portion of the payment, wherein the operations further comprise:
in response to a determination that the third user selectable option has been selected by the recipient, sending a notification to the sender that the recipient has accepted responsibility for at least the portion of the payment.

20. The non-transitory machine-readable medium of claim 17, wherein the message request includes a fourth user selectable option indicating that the recipient will decide later whether to accept responsibility for the payment, wherein the operations further comprise:
in response to a determination that the fourth user selectable option has been selected by the recipient, sending a notification to the sender that the recipient will decide later whether to accept responsibility for the payment.
